(19) United States
(12) Patent Application Publication
(10) Pub. No.: US 2026/0044919 A1
(43) Pub. Date: Feb. 12, 2026

(54) Neural-Network Based Visibility Modeling Using Just Noticeable Difference Training Data

(71) Applicant: Digimarc Corporation, Beaverton, OR (US)

(72) Inventors: Manish Sharma, Wilsonville, OR (US); Tomas Filler, Beaverton, OR (US)

(21) Appl. No.: 19/288,674

(22) Filed: Aug. 1, 2025

Related U.S. Application Data
(60) Provisional application No. 63/681,567, filed on Aug. 9, 2024.

(51) Int. Cl. G06T 1/00

(52) U.S. Cl. CPC G06T 1/0028

(57) ABSTRACT

A neural-network is trained to produce a visibility model based on just noticeable difference training data. The trained network is used to generate visibility masks to control the visual quality of image processing operations, such as digital watermarking, compression and other image editing operations. The visibility model is refined by iteratively adjusting for over and under predictions of a just noticeable difference threshold via an interactive user interface that pinpoints visual artifacts and captures updates from users, who provide adjustments such that the artifact is below what they perceive to be a just noticeable difference. Image processing, such as digital watermarking is performed in real time to provide the user with feedback to ascertain just noticeable difference levels corresponding to watermark embedding operations.

### RELATED APPLICATION DATA

This application claims the benefit of U.S. Provisional Application No. 63/681,567, filed Aug. 9, 2024, which is hereby incorporated herein by reference in its entirety.

### TECHNICAL FIELD

The invention relates to visibility models and applications of visibility models to control visual quality of image processing operations, such as digital watermarking.

### BACKGROUND AND SUMMARY

In image processing, visibility models are an important tool to ensure that manipulations to image content do not introduce visual artifacts that degrade the aesthetic quality of still images and video content. This is particularly the case in the field of digital watermarking where the embedded watermark's data carrying capacity and its ability to survive degradation are limited by visual quality. To maximize data carrying capacity, more signal energy is needed to convey the data reliably. Similarly, to increase robustness of the watermark to degradations, more signal energy is needed to withstand degradations and enable reliable watermark signal recovery. However, increasing the watermark signal also increases the likelihood that human viewers will notice artifacts in the image due to the watermark embedding. Thus, there is a need for visibility models that more effectively mask the watermark signal. Likewise, this challenge applies to other image processing operations, like compression, where there is a need to avoid image artifacts and maintain visual quality.

Various visibility models exist for applications like digital watermarking, compression, visual quality enhancement, and image editing tools. In these applications, the visibility models quantify the amount of modification that image features can tolerate while retaining a desired level of visual quality. One way to control image impact is to quantify image modification in a data structure, called a mask, comprised of an array of signal strength values corresponding to image feature locations. Some of these models use differences in pixel values relative to an original or reference as a proxy for what a human viewer would find objectionable. More sophisticated models leverage additional attributes of the image like edges, image activity and texture, and color to generate visibility models. These models incorporate knowledge of the human visual system to derive the visibility mask. The advent of machine learning technologies has spurred the development of visibility models derived from training networks to discern visual quality.

While these methods show promise, they tend to suffer from either over-predicting or under-predicting the visibility of a change in image features. Visual quality data provided by human viewers is often useful but impractical to apply within image processing applications. There is a need for improved visibility models that are computationally efficient to generate and apply in an automated fashion at large scale.

This specification describes methods for training a neural-network to generate visibility models and using these models to control the visual quality of image editing operations, such as digital watermark embedding, compression, image enhancement (e.g., generative fill) and the like. While we illustrate practical application of these methods to digital watermarking of image content, they apply to other image processing operations where the introduction of visible artifacts is a concern.

A neural-network may include a computational model inspired by the structure and function of biological neural-networks, particularly the human brain. Neural-networks often include interconnected nodes (neurons) organized in layers, including an input layer that receives data, one or more hidden layers that process information, and an output layer that produces results. Each connection between neurons may include an associated weight that determines the strength of a signal transmitted between nodes. During operation, input data flows through the network via weighted connections, with each neuron applying an activation function to transform the sum of its weighted inputs before passing the result to subsequent layers. Neural-networks can learn by adjusting these weights through a training process that typically involves presenting the network with training examples and using optimization algorithms (such as gradient descent) to minimize the difference between predicted and actual outputs. This learning capability enables neural-networks to recognize complex patterns, make predictions, and perform tasks such as classification, regression, and feature extraction. Some modern neural-network architectures, including convolutional neural-networks (CNNs), recurrent neural-networks (RNNs), and transformer networks, can be effective for processing structured data such as images, sequences, and natural language.

The present technology adapts and modifies a general neural-network framework specifically for visibility modeling by incorporating human perceptual data in the form of Just Noticeable Difference (JND) measurements as ground truth training labels. Unlike conventional neural-networks that may be trained on objective metrics or automated labeling systems, our approach leverages subjective human visual assessments captured through an interactive interface where users adjust signal strength parameters until image artifacts reach their personal perception threshold. In one implementation, our network architecture is designed as a regression model that predicts continuous JND strength values rather than discrete classifications, employing specialized components including ResNet-inspired convolutional blocks for feature extraction, self-attention mechanisms in fully-connected layers for enhanced pattern recognition, and a modified sigmoid output activation function that constrains predictions within empirically-determined JND strength ranges (e.g., 0.003 to 0.243). One example training process treats visibility prediction as a regression problem, minimizing the difference between predicted strength values and human-assessed JND values using loss functions such as Mean Squared Error. In another implementation, a human-perception training approach enables the network to learn complex relationships between image features (such as texture, edges, contrast, and spatial frequencies) and human visual perception, producing visibility masks that can effectively control image processing operations like digital watermarking to remain imperceptible to human viewers while maximizing signal robustness and data capacity.

One aspect of the invention is a method for training a neural-network to create visibility models, leveraging just noticeable difference (JND) data captured through an interactive user interface. The interactive user interface displays test images and captures user input of signal strength for image features within the test images. The interface presents a user interface element that enables a user to adjust the signal strength for the image features while viewing the test image on the display. The user inputs a JND signal strength that represents a just noticeable difference of image artifacts at image features. This data capture process outputs training data comprising image features and corresponding JND strength for a training set of test images. A training pipeline then trains a neural-network to construct a visibility model from the training data.

This visibility model is a trained neural-network that predicts JND strength values from input images. The visibility model is used to predict JND strength values for an input image. In turn, these predicted JND strength values are used to generate a visibility mask that controls visibility of image processing operations on the input image.

Another aspect of the invention is a method of applying visibility models to improve the visual quality of digital watermarking of image content, including still images and video. The visibility model transforms input image content into strength values, which in turn, are used to generate a visibility mask for controlling watermark embedding.

Additional aspects and inventive features will become apparent from the following detailed description and accompanying claims.

### BRIEF DESCRIPTION OF THE DRAWINGS

FIG. 1 depicts a screen shot of a data capture program used to capture JND data for training images.

FIG. 2 is a block diagram illustrating a system for training a neural-network to produce a visibility model based on JND training data.

FIG. 3 illustrates a convolution block (ConvBlock) used in a network trained to produce visibility models.

FIG. 4 illustrates a residual block (ResBlock) of the network.

FIG. 5 illustrates an input block (InBlock) of the network.

FIG. 6 illustrates an output block (OutBlock) of the network.

FIG. 7 illustrates an example of the network trained to produce a visibility model.

FIG. 8 illustrates a Fully Connected Block (FCBlock) of the network.

FIG. 9 is a block diagram illustrating use of a trained neural-network visibility model to generate and apply a visibility mask.

FIG. 10 is a flow diagram illustrating a process of refining a neural-network visibility model.

FIG. 11 is a diagram of a computing environment used to implement components of the present technology.

### DETAILED DESCRIPTION

This specification describes a system for training a neural-network to create a visibility model based on Just Noticeable Difference (JND) training data. The trained network is then used to control visibility of image processing operations, specifically digital watermark embedding. Three components to this system include: an interactive user interface for capturing JND training data, a programmed computer system for training a neural-network based on the JND training data, and a programmed computer system for using the trained neural-network to produce visibility masks. The specification further describes systems and methods for refining the visibility model and applying it to control the visual quality of digital watermark embedding.

A visibility mask is a data structure used to control the visual quality of an image processing operation. In this specification, we describe how to create and apply a visibility mask for image content, including still images and video. For still images, the visibility mask controls the visual impact of an image editing operation on image features within an image. For video, the visibility mask controls the visual impact of an image editing operation on image features over a time sequence of video frames. While we illustrate systems and methods for creating and using masks for digital watermark embedding in images, they apply to other types of image processing, such as image editing, compression, and the like.

In embodiments for digital watermarking, the visibility mask comprises an array of strength values that correspond to the digital watermark strength at image feature locations in a feature coordinate space. In these embodiments, the features correspond to pixel locations in the spatial domain of an image. The methodology also applies to feature locations in a transform domain of image content. Examples include a frequency domain transform, such as Fourier transform or Discrete Cosine Transform domain, a wavelet transform domain, or feature space generated by applying a neural-network to an image, such as a Convolutional Neural-network, Recurrent Neural-network, or the like.

The visibility mask is designed to control the amount of change that an image processing operation will introduce to an image feature based on a desired visual quality. Image quality is inherently subjective, and as such, it is useful to assess visual quality using knowledge of the human visual system and input from human viewers. The types of changes that a digital watermark embedding operation introduces into an image varies with the type of digital watermark method. For example, the watermark may be applied at varying levels of spatial resolution, within different types of features, like edges and textures, within different spatial frequencies, and different image attributes like colors and luminance. Dominant factors influencing visibility include texture, edges, contrast, spatial frequencies, and luminance, to name a few. Secondary factors include, but are not limited to, the viewing distance, display medium (e.g., type of device), viewing angle, and an observer's viewing acuity.

The objective of digital watermarking for many applications is to maximize the digital watermark signal robustness for a given amount of visibility. Robustness refers to the ability of the watermark to be recovered reliably despite degradations that the watermarked content may encounter (malicious or non-malicious). Highly textured regions tend to be able to tolerate more digital watermark signals before the changes introduced by the watermark become visible. Flat regions can tolerate less digital watermark signal. Because the visual impact of digital watermarking varies with image features and the relationship between these features and the modifications of the image to embed a watermark, it is advantageous to assess the visual impact of the watermark using human viewers. However, it is not practical to have human viewers assess each watermark embedding operation. To leverage the power of human viewer input, we train and refine visibility models using JND training data.

The goal of our visibility models is to limit the visual impact of image editing operations, such as watermark embedding, to one JND. This is the maximum change to an image feature not detectable by the human visual system, as determined by input from human viewers. For digital watermarking, our visibility models are designed to adapt the signal strength of the digital watermark to maximize watermark signal robustness while remaining at or below one JND.

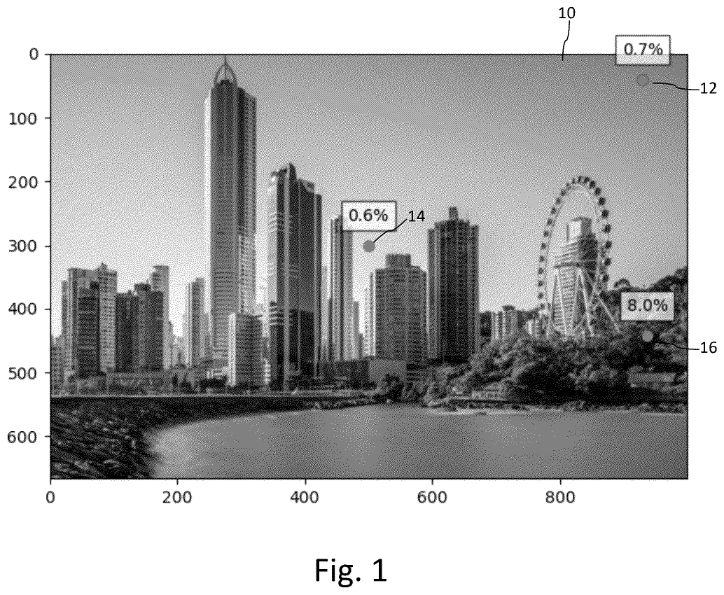

FIG. 1 depicts a screen shot 10 of a data capture program used to capture JND data for a test image. The data capture program, executed on a computer, displays a test image on a display device (e.g., monitor or touch screen) and records JND strength and feature location input from human viewers. Using this program, the user evaluates the test image, identifies features where an image processing operation has introduced a visible artifact, and adjusts the strength value of each identified feature so that the artifact is no longer visible. The user selects each feature location within the image using cursor control device such as mouse, touch pad, or touch screen. The feature location corresponds to a region within an image, e.g., an image patch, the dimensions of which are configurable. In our testing of various embodiments, we have found that a patch of having a size of 15 to 17 pixels by 15 to 17 pixels, within an image of 1000 by 600 pixels provides effective results. We experimented with images of varying resolutions and found that the method is relatively independent of image resolution. To adjust the strength value to a JND, enters a numeric value corresponding to the JND strength value via an input device, such as a keyboard, keypad, voice recognition device, or the like, to a user interface element (e.g., text entry box, menu, slider bar, or like control). For digital watermark embedding, where the digital watermark is encoded across the image or image region, the user may enter the strength value as a scale factor value for a feature location multiplied by a baseline signal strength value of the digital watermark applied across all feature locations in a region or the entire image.

In the example depicted in FIG. 1, the user has selected three feature locations to adjust signal strength of a digital watermark to one JND level. The screen shot 10 depicts a test image and highlights these three feature locations (12, 14, and 16), each representing the user's adjustments to the signal strength of the watermark to one JND level. At location 12, the user has adjusted the JND strength value to 0.7% to account for the watermark being potentially visible in this region where the image content is flat. At location 14, the user has adjusted the JND strength value to 0.6% to account for the watermark being potentially visible in the sky near the edges of the buildings in the center of the image, where the image content is flat, near edges, and in the center where the user's attention is more likely to be drawn. Finally, at location 16, the user has increased the strength level to 8% to account for the watermark being less visible in the textured area around the trees and outside the areas of interest in the image. The % values are the values of the strength applied to the watermark at that pixel location to be at JND. A strength of 1 (or 100%) means apply the watermark as is to the image at that location. In the 0.6% case, during embedding, the watermark will be multiplied by 0.006 at that location. Overall, the range of this strength value is usually 0.6%-25%, with a few outliers that may go higher.

The JND data capture system enables the user to adjust the strength within a watermarked image. After the system watermarks the image with a mask candidate, it displays the watermarked image. From there, while focusing on specific locations in the image, the user can adjust the global strength of the watermark. For example, if the user is looking at feature location 16 and it seems like more strength could be applied there without crossing one JND, they slowly increase the global strength from 100% to 200%, and the watermark strength at that location goes from 8% to 16%. At the same time, the watermark strength at feature location 12 will go from 0.7% to 1.4%, since it is the global strength that is being adjusted. This will likely impact visibility of the watermark at that location, but is not relevant when focusing on location 16. If at 16%, the watermark at location 16 becomes just noticeable, that JND strength is recorded for that location, and the user will repeat this process across points of interest in the image.

The structured training dataset may include comprehensive metadata comprising image characteristics (e.g., resolution, color depth, content type), user identification (e.g., for tracking individual assessor consistency), viewing conditions (e.g., ambient lighting, viewing distance), and display device specifications (e.g., color gamut, brightness, contrast ratio). This metadata enables analysis of factors that may influence JND assessments across different users and viewing environments.

The system can be configured to organize training data by image categories (e.g., portraits, landscapes, textures, etc.), user demographics (e.g., age, visual acuity, experience level), and statistical distributions of JND threshold values to identify patterns and potential biases in the collected data. Quality control validation compares JND threshold values across multiple users for identical feature locations, calculating inter-user agreement statistics and flagging outlier measurements that deviate significantly from the consensus for manual review by expert assessors.

The interactive interface may include various user interface controls to facilitate precise JND data collection. In one embodiment, the strength adjustment control comprises a slider interface that provides continuous adjustment of strength values between predetermined minimum and maximum thresholds, typically ranging from 0.1% to 50% of baseline watermark strength. The system can be optimized for real-time responsiveness, applying adjusted strength parameters to the watermark embedding operation and refreshing the displayed test image within a response time of less than 500 milliseconds (e.g., less than 400 ms, less than 300 ms, less than 200 ms, less than 100 ms, etc.) to provide responsive visual feedback to the user.

To ensure data quality and consistency, the system may include validation mechanisms that require users to confirm JND threshold values through repeated testing at randomly selected feature locations. The interface displays visual indicators overlaid on the test image, such as colored dots or outlined regions, to highlight previously selected feature locations and their corresponding JND threshold values, enabling users to track their progress and review previous assessments. Such validation processes account for natural variation in human perception by allowing JND measurements within a tolerance range rather than requiring exact repeatability.

The system can be configured to automatically suggest candidate feature locations for user evaluation based on predetermined image analysis criteria. These suggestions are generated using texture analysis algorithms that identify regions with varying levels of detail, edge detection algorithms that locate boundaries between different image regions, and contrast analysis that identifies areas where watermark visibility may vary significantly.

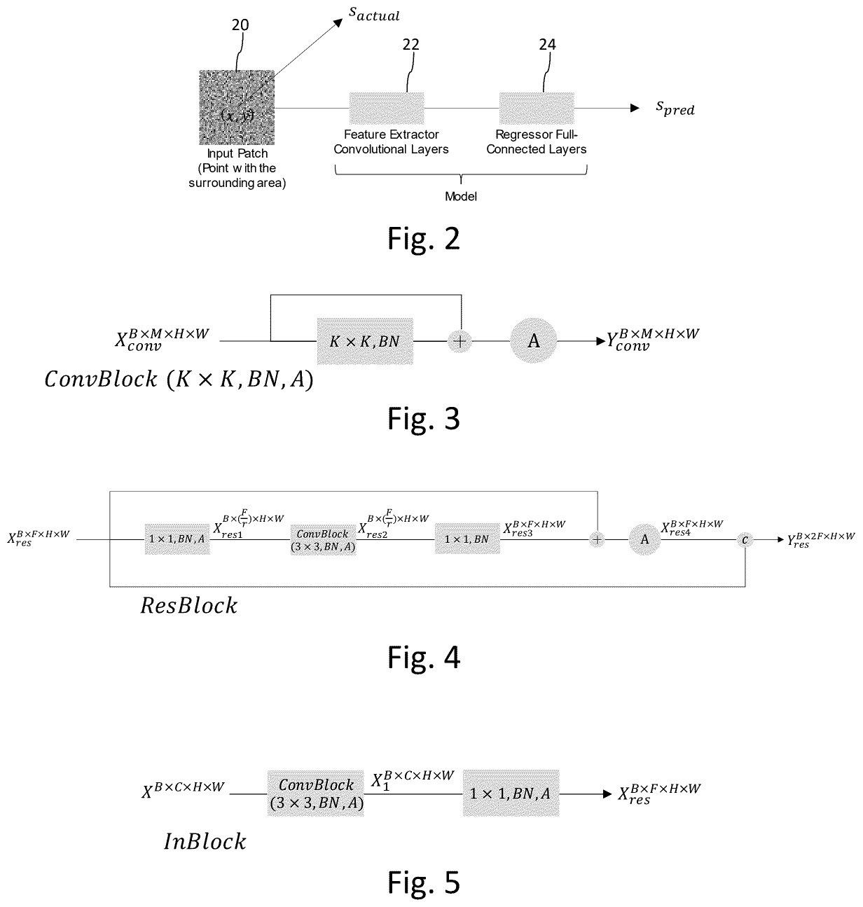

FIG. 2 is a block diagram illustrating a system for training a neural-network to produce a visibility model based on JND training data. This is the training pipeline. To train the network, the training pipeline takes as input image features and JND strength values for those features. The training pipeline uses this input as ground truth to learn how image features relate to the visual quality perceived by a human viewer, as expressed in the JND value. In this embodiment, the training process operates on patches of a test image surrounding the point selected by the user when inputting the JND strength value. The system is configurable to operate on a set of selected patches of each image or full images, with corresponding JND strength values input by human viewers for these patches at selected locations. The training pipeline treats the learning process as a regression to adapt the predicted strength values (Spred) in a visibility mask to the JND strength values (Sactual). The output of the training system is a NN-based model that predicts the JND strength value for each feature location (e.g., each image patch for user selected locations). To generate a mask, the strength values are mapped to the feature locations of the patches within an image. In this embodiment, these feature locations are spatial coordinates of pixels in the spatial domain of each image. The mask comprises a pixel-wise matrix of strength values to be applied to corresponding image pixel values (e.g., in RGB color channels). JND adjustments are inserted at their respective locations and blended with baseline strength values to provide smooth transitions over the image. As noted, the features and feature locations of JND adjustments may vary, e.g., by feature type and feature location, to adapt to the image processing application (e.g., the digital watermark embedding method, compression, image editing, or the like).

The neural-network architecture comprises neural-network layers, including feature extractor layers 22 and fully-connected regressor layers 24.

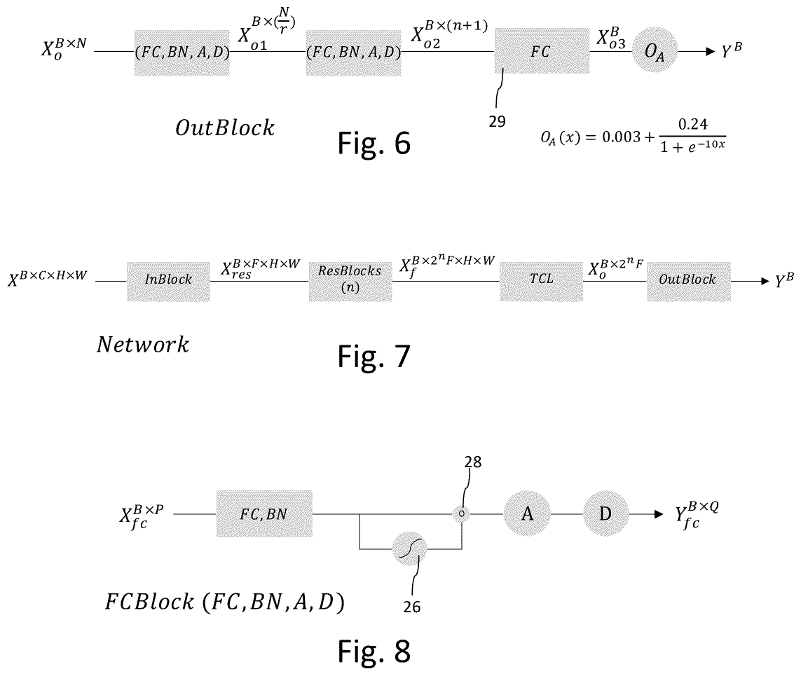

To illustrate an implementation in more detail, we include FIGS. 3-8 depicting components of the neural-network. FIG. 3 illustrates a convolution block (ConvBlock) used in the network. It includes a convolutional layer (K×K), followed by a batch normalization (BN). A skip connection (or lateral skip connection) adds the output of this layer to its input. The result is passed through an activation function (A). FIG. 4 illustrates a residual block (ResBlock) of the network. It has convolution layers (including a pointwise convolution (1×1) and a ConvBlock), skip connection, activation function (A) and concatenation (C). FIG. 5 illustrates an input block (InBlock) of the network. It has a Convolution Block (ConvBlock), pointwise convolution (1×1), batch normalization (BN), and activation function (A). FIG. 6 illustrates an output block (OutBlock) of the network. FC refers to Fully Connected layer and D refers to a Drop-out layer. OA is an Output Activation function. FIG. 7 illustrates an example of the network, comprised of the input block (InBlock), residual blocks (ResBlocks), Tensor Connection Layer (TCL), and output block (OutBlock). Finally, FIG. 8 illustrates a Fully Connected Block (FCBlock) of the network. It includes a Fully Connected layer (FC), Batch Normalization (BN), self-attention mechanism 26, product operator 28 (which combines the input and output), Activation function (A), and Drop-out layer (D). We detail an example of these components in operation within the network of FIG. 7 below.

The feature extractor layers 22 are convolutional layers that take color image input (e.g., in RGB format) and transform them into channels representing a feature map. In the illustrated embodiment, the feature extractor layers employ the convolutional neural-network architecture inspired by ResNet. Referring to FIG. 7, the input to the input block (InBlock) is a training set, X^{B×C×H×W}, where B is the batch size (the number of image patches, e.g., 100 in the batch), and C refers to the channels of the input, of which there are 3, corresponding to Red, Green, and Blue channels of the input images. H and W are the height and width of the input images (e.g., patches) in pixels, which are provided along with a JND strength values.

Referring to the input block (InBlock) of FIG. 5, the first layer is a depthwise convolutional layer with a kernel size of 3, padding of 1 on each spatial side of the input, and a stride of 1. This layer is followed by a Batch Normalization (BN) layer and a skip-connection that takes the input of this layer and sums it up with the output of a batch normalization layer before passing the summed output through a Sigmoid Linear Unit (“SiLU”) activation function. This function is then followed by a pointwise convolution layer to increase the depth of feature map channels. Its output is then passed through a batch normalization layer and a SilU activation function. This initial part of the feature extractor layers 22 works as a primary stage that learns basic set of features and sets the stage by raising the dimension of feature maps from 3 to F before feeding it to the modular and scalable part of the feature extractor layers. F is the number of channels of the feature vector. In our development, we found 8 channels to be suitable, though the number of channels may vary (e.g., 8, 16, 32, etc.).

As shown in residual block (ResBlock) in FIG. 4, subsequent layers in the feature extractor layers 22 of the network are modified bottleneck style residual blocks (ResBlock of FIG. 4) like ResNet, each consisting of three convolutional layers (pointwise convolutional layer followed by depthwise convolutional layer (stride 1 and padding 1) (the ConvBlock in FIG. 4) followed by a pointwise convolutional layer), with batch normalization and SilU activations after each convolution. Each of these residual blocks has a shortcut skip-connection that bypasses the sequence of these three convolutional layers and adds it back to the output of the convolutional layers in the block (before the final activation function in the block). Moreover, input of each of these residual blocks is stacked along channel dimension (depth-wise) with the output of the residual block after the final activation function. This raises the channel dimension from F to 2F without altering spatial dimensions for the next residual block to process it further.

Referring again to the network of FIG. 7, these residual blocks are stacked in a sequence in the network, one after another such that after n residual blocks, the channel dimension of the output feature maps becomes 2ⁿ F whereas spatial dimensions remain the same. Due to the modular nature of these residual blocks, we can change the network depth (number of layers) and its learning capacity simply by changing the scaling factor n.

The network architecture of the regressor layers 24 includes input, hidden and output layers. After the final residual block of the feature extractor, a Tensor Contraction Layer (TCL) (FIG. 7) acts as an input layer to contract the spatial dimensions and aggregate the spatial signal while preserving spatial information using learnable weights instead of traditional global average pooling layer which destroys the spatial relationships. This reduces the spatial dimensions to 1 without altering the depth of feature maps, summarizing the spatial features into a flat vector. This vector is then fed into the hidden layers (Fully-Connected layers) of the regressor layers 24. These layers are depicted in output block (OutBlock of the network of FIG. 7, shown in more detail in FIG. 6). FIG. 8 illustrates a Fully Connected Block (FC, BN, A, D) shown in the first two stages of the OutBlock of FIG. 6.

As shown in FIG. 6, the input and output to the first hidden layer are vectors of length 2ⁿ F and 2ⁿ⁻² F, respectively. The Fully Connected layer (FC) of a Fully Connected Block (FIG. 8) is followed by a Batch Normalization (BN) layer, a self-attention mechanism 26, SiLU activation function (A) and a Drop-out layer (D) (for regularization), which are shown in more detail in the FCBlock of FIG. 8. The next and final hidden layer of FIG. 6 is a fully-connected layer with output size n+1. This layer is again followed by a batch normalization layer, a self-attention mechanism, SiLU activation function and a Drop-out layer. These two hidden layers work in a sequence and condense the features from size 2ⁿ F to n+1 features.

The self-attention mechanism 26 implemented within the Fully Connected Block (FCBlock) enables the neural-network to selectively focus on the most relevant features for visibility prediction based on their contextual importance. Unlike traditional fully connected layers that treat all inputs with equal importance, the self-attention mechanism 26 can be configured to compute dynamic weights for each feature based on its relationship with other features in the same representation. For example, the self-attention mechanism 26 first transforms the input features through a series of learnable projections to create query, key, and value representations. The similarity between query and key representations determines attention scores, which are then normalized using, e.g., a softmax function, to create a probability distribution. These attention weights can be applied to the value representations, allowing the network to emphasize features that are most relevant for predicting JND thresholds in the current image context. This approach is particularly effective for visibility modeling because it enables the neural-network to adaptively focus on different aspects of image content—such as edges, textures, or flat regions—depending on their perceptual significance in each specific image area. The self-attention mechanism 26 thereby improves the network's ability to capture complex relationships between image characteristics and human visual perception thresholds across diverse content types.

The output Fully-Connected (FC) layer 29 (FIG. 6) takes input features of size n+1 and outputs a single feature value. This output is passed through a modified sigmoid output activation function (OA), e.g., 0.003+0.24/(1+e^{-10x}), to get the predicted strength value for the corresponding input image patch. The chosen activation function allows us to limit the strength prediction between the floor (0.003) and ceiling (0.243) values of the masking strength. Another option for the activation function is a standard sigmoid activation function but that would require post-processing steps.

Alternative embodiments of the neural-network employ an encoder-decoder architecture with lateral skip connections between corresponding encoder and decoder layers. The encoder progressively reduces spatial dimensions while increasing feature depth, and the decoder reconstructs the spatial resolution while the lateral skip connections preserve fine-grained spatial information that is crucial for accurate visibility prediction.

The self-attention mechanism can be implemented as a multi-head attention system operating across different spatial scales simultaneously. Each attention head can focus on different aspects of the feature representations, which may correspond to visual features such as texture patterns, edge information, or spatial relationships, enabling the neural-network to weight feature importance based on both local characteristics and global image context.

In such alternative embodiments, an adaptive pooling layer dynamically adjusts receptive field sizes based on local image characteristics determined through real-time texture analysis and/or edge density measurements. In regions with high texture detail, smaller receptive fields preserve fine spatial information, while in uniform regions, larger receptive fields capture broader contextual patterns.

The network architecture can be configured to incorporate depth wise separable convolutions in the feature extraction layers to reduce computational complexity while maintaining feature extraction effectiveness. This optimization enables real-time processing for practical applications while preserving the network's ability to capture complex visual patterns.

Residual connections with learnable gating mechanisms can be added to control information flow through the network, allowing the neural-network system to adaptively determine which features from earlier layers should be preserved and combined with features from deeper layers. The output interface can generate multi-channel spatial maps representing predicted strength values for different types of image processing operations (e.g., digital watermarking, compression, noise reduction, etc.) simultaneously through multi-task learning components.

The features in the network are passed through non-linear activation functions to help the network learn patterns in the image that impact visibility. In our development, we tested a variety of non-linear activation functions and found SiLU to perform well. Unlike ReLU (Rectified Linear Unit), which zeroes out negative inputs, SiLU maintains a non-zero gradient for negative inputs. This helps in avoiding the “dying ReLU” problem, where neurons can get stuck and never activate. The output of SiLU is a product of the input and its sigmoid gate, making it a self-gating activation function. This self-gating mechanism helps to regulate the flow of information and gradients through the network, which can lead to better gradient propagation and more stable training.

The training pipeline trains the network by adjusting the parameters of the network (e.g., the weights) to optimize a loss function. In a first embodiment, we use Mean Squared Error (MSE), the averaged squared difference between the predicted and actual value (the JND value) as the loss function. In alternative embodiments, we use Mean Absolute Error, which measures the average magnitude of errors without considering the direction (i.e. the average over the absolute values of the errors).

The training process of neural-networks often involves the application of optimization algorithms to minimize the loss function. Two widely used algorithms in this context are Gradient Descent (GD) and Stochastic Gradient Descent (SGD), along with their numerous variants. Gradient Descent adjusts the weights incrementally based on the gradient of the loss function with respect to the weights, computed over the entire dataset. This leads to stable and deterministic updates, which are beneficial for a smooth convergence. However, the computational expense and memory requirements can be prohibitive, especially for large datasets. On the other hand, Stochastic Gradient Descent updates the model parameters more frequently by using a single data point or a mini-batch for each iteration. This results in faster updates and often better generalization by escaping local minima due to its inherent noise. Nevertheless, the frequent updates can introduce high variance in the loss function, making the convergence path more erratic and potentially less stable. Variants of SGD, such as Adam and RMSprop, address some of these issues by adapting the learning rate during training. ADAM (Adaptive Moment Estimation) combines the advantages of both Momentum and RMSprop, adjusting the learning rate based on the first and second moments of the gradients. This adaptation makes Adam particularly effective for problems with sparse gradients, leading to faster and more stable convergence. We used ADAM as an optimizer during our training to optimize the weights based on loss and computed gradients. Further, to regulate the learning rate during training, we use reduce on plateau as the learning rate scheduler to reduce the base learning rate (1e-2) by a factor of 0.1 if the loss does not improve by a provided delta (1e-4) for 10 successive epochs.

The training process performs forward propagation, backpropagation, and iterates for several epochs or until the loss does not improve for certain number of epochs (e.g., 25). Forward propagation computes the predicted output values based on the current weights of the network. Back propagation updates the weights of the network by calculating the gradient of the loss function with respect to each weight and adjusting the weights to minimize the loss. The training pipeline repeats this process for the lesser of a maximum number of epochs (e.g., 100) or the number of epochs after which the loss stops improving.

In addition to the loss function used during training, other metrics like R-squared, Root Mean Squared Error (RMSE), or adjusted R-squared can be used to evaluate the performance of the regression model on validation or test data. To address overfitting, we found it useful to implement regularization (L1, L2), Drop-out, and limiting the number of minimum epochs of training up to 25 epochs. This helps the model generalize to new, unseen image data.

While this embodiment operates on image patches and returns a predicted strength value for each patch, alternative embodiments are designed to operate on the full input image, which enables the model to assess all features of an input image, as opposed to the patch around each feature selected by the users to adjust the strength to a JND.

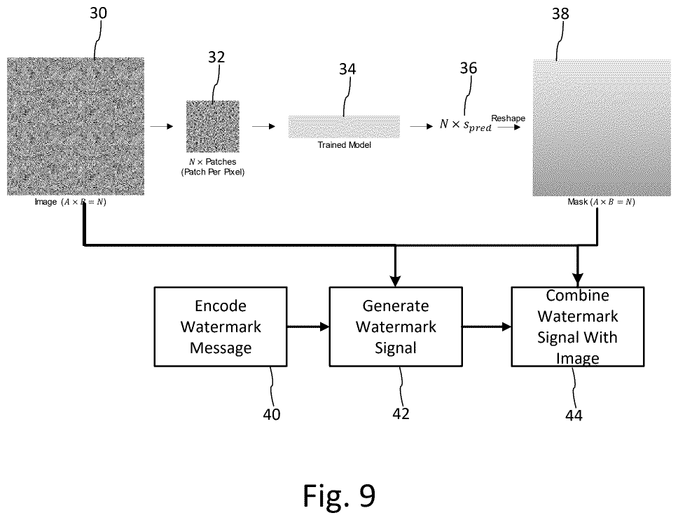

FIG. 9 is a block diagram illustrating the application of the trained model to generate and use a visibility mask. The components of the system that generate the mask are the inference pipeline (30, 32, 34, 36, 38). The inference pipeline takes an input image 30 of dimensions A×B, converts it to N patches (A×B=N) 32, and applies the trained model 34 to predict strength values (Spred) 36 for each of the N patches. It then reshapes and assembles the strength values to correspond to feature locations in mask 38, a two-dimensional vector (A×B) of strength values of dimensions corresponding to the input image that predict JND strength within the image. This mask is then used to control the magnitude of changes to the image in image processing operations such that the changes remain within a JND.

FIG. 9 depicts digital watermark embedding as one such example of an image processing operation. The digital watermark embedding process performs message encoding 40, generates a watermark signal 42, and combines it with the input image 44 using the mask 38 to control strength of the watermark signal. In applications where the digital watermark conveys a plural-bit message, that plural bit message is encoded using an error correction coding method, such as Reed Solomon, block coding (e.g., BCH), convolution coding, turbo coding, or the like. In other applications, the watermark may not convey message bits; its presence or absence provides the desired indicator of the content item (e.g., the content is protected, generated from a particular source, or the like).

In other embodiments, the encoding block 40 is a trained channel coder, which is jointly or separately trained with other components of the watermark encoder and decoder (e.g., to optimize the watermark method for robustness and perceptual quality).

The watermark generator block 42 produces a watermark signal that is embedded within the input image. One method for producing the watermark signal is to spread it over a carrier signal, such as a pseudorandom spreading signal or feature vector of the host image, by multiplying, convolving or bit-wise XOR'ing it with the carrier signal. The watermark signal may be repeated in rectangular or square tiles that are then mapped to corresponding contiguous regions within the image. Alternatively, the watermark may be shaped to fit a fixed image size or transformed to fit the size of the input image.

The watermark signal may also be generated using a trained neural-network (NN) to function as a watermark generator or watermarked signal generator. A NN watermark generator outputs a watermark signal that is separately blended with the host image, whereas a NN watermarked signal generator is trained to generate a watermarked image. Both types of NN systems are trained based on an input message, input training images, and loss functions. Selected based on the design requirements of the application, these loss functions can include loss functions for perceptibility, robustness (e.g., via generative adversarial network, or pre-determined signal transformations), message accuracy, and the like.

These NN based components may be jointly or separately trained with other components of the watermark embedder and reader. In one embodiment, the training employs an auto-encoder-decoder architecture for the embedder, in which a neural-network is used to transform the image to a feature vector space, where the watermark signal is applied (e.g., concatenated with a feature vector), and then transformed by subsequent “decoder” layers of the auto-encoder-decoder of the watermark embedder into either a watermarked image or watermark signal, separately combined with the input image.

We use the phrase, “watermark reader” to refer to the programmed system that detects and extracts the watermark message (the “payload”) from a watermarked image. The watermark reader is distinct from the decoder component in the auto-encoder-decoder network configuration of the watermark embedder. In some embodiments, the watermark reader is programmed to detect and extract the watermark, using an implicit or explicit synchronization signal. An implicit synchronization signal is formed inherently from the message carrying component of the watermark signal. An explicit synchronization signal is an additional signal component relative to the message carrying component. Some watermark readers do not employ explicit synchronization or a synchronization step, but instead read the watermark from a domain (e.g., a feature vector space) selected or trained to be robust to an expected set of distortions, including geometric transformations, including rotation, scale changes, translation, differential scale, perspective transforms, and the like.

After synchronization (if needed), the watermark reader reverses the process of spreading the watermark over the carrier and error correction or channel coding to extract the message. The watermark reader may also be programmed by training a NN jointly with or separately from the training of the watermark embedder. For example, a ResNet architecture may be adapted and trained to detect the watermark, and to extract a watermark signal, from which the message is extracted through error correction decoding (e.g., soft decoding using a Viterbi decoder or alternative error correction or channel decoding methodology, like those noted above).

In block 44, the watermark embedder applies the mask to control the strength of the watermark. One way to control strength is to multiply the watermark signal generated in block 42 by the strength values in the mask 38. This may be achieved by blending the watermark signal into one or more color or luminance channels of the image, controlled by corresponding strength values of feature locations (e.g., pixel coordinates, transform domain coefficients, wavelet domain bands, etc.) in the mask. Another way to control strength is to use the mask to control the strength of the watermark within trained watermark embedder, e.g., an auto-encoder-decoder architecture described above. In this case, watermark signal generator 42 and combiner block 44 are integrated within the auto encoder-decoder architecture.

The real-time mask generation system may process input images at multiple resolution levels, generating coarse masks at reduced resolution for computational efficiency and fine masks at full resolution for detail preservation, then combining results through upsampling interpolation and learned fusion weights to produce multi-scale visibility masks that capture both global and local visibility characteristics.

The parallel processing framework can be configured to employ GPU acceleration with optimized memory management, partitioning large images into tiles with appropriate overlap to handle boundary effects that can be processed simultaneously across multiple GPU cores. Memory optimization techniques include, e.g., pre-allocated buffer pools and streaming data transfer to minimize latency for high-resolution image processing.

Spatial smoothing in the mask refinement module can employ edge-preserving filters such as bilateral filtering or guided filtering to prevent visibility discontinuities at mask boundaries while preserving important transitions that correspond to actual changes in image content. Quality monitoring employs statistical analysis of pixel-level changes, computing metrics such as peak signal-to-noise ratio (PSNR) and structural similarity index (SSIM) to detect potential visibility violations. The choice of filter may depend on the specific image characteristics and processing requirements.

The feedback control system can be configured to implement adaptive learning mechanisms that track the accuracy of visibility predictions over time and adjust post-processing parameters or trigger model retraining or post-processing algorithms to improve performance. A preprocessing module normalizes input images by adjusting brightness and contrast to standard ranges and applies color space transformations (such as conversion to perceptually uniform color spaces like CIELAB) that are optimized for human visual perception modeling.

To improve computational efficiency, the mask generation engine can be configured to maintain a cache of frequently accessed mask patterns corresponding to common image features (uniform regions, typical textures, standard edge patterns), reducing computational overhead when similar image regions are encountered. For video processing, a post-processing module applies temporal consistency constraints using motion estimation techniques and temporal smoothing algorithms to prevent visibility flickering between frames that could draw viewer attention.

In some configurations, the system generates confidence scores for mask predictions based on prediction variance, activation magnitude distributions, or ensemble disagreement measures, flagging low-confidence regions where the visibility predictions may be unreliable for manual review or alternative processing approaches. An integration interface can provide standardized APIs and plugin architectures that enable incorporation of the visibility mask system into existing image processing pipelines with minimal modification requirements.

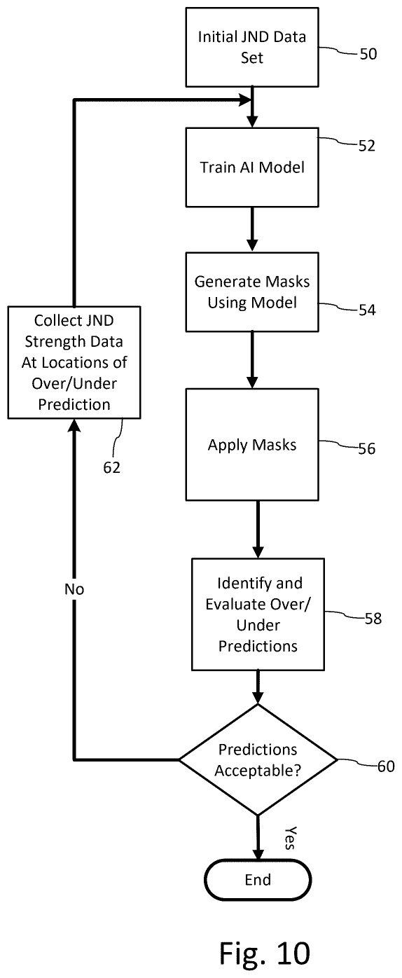

FIG. 10 is a flow diagram illustrating a method for refining a visibility model using JND data in an iterative process. In block 50, the process begins as described above with the capture of JND data from human viewers, observing images that have been processed (e.g., edited, watermarked, compressed, etc.). The human viewers provide the initial set of ground truth strength values, including JND strength values at selected locations within training images, for training the Artificial Intelligence (AI) based model in block 52. From this model, the process generates masks for training images in block 54. In block 56, these masks are applied to control visibility of an image processing operation on the training images to produce output images that human viewers analyze, along with the predicted strength values. In block 58, human viewers use the application depicted in FIG. 1 to identify locations where the strength values represent over and under predictions and evaluate whether to adjust JND strength values. An over prediction is where the strength value induces a more noticeable difference than one JND, and an under prediction is where the strength value corresponds to a change that is below one JND. For applications like watermark embedding, all strength values should be as close to one JND strength as possible.

The refinement process assesses whether the predictions are acceptable by determining the extent to which they are within an acceptable range of one JND. This acceptable range may be a fixed difference, adaptable by the user, or adaptable by the system after learning what human viewers find to be acceptable. As illustrated by decision block 60, if they are within an acceptable range, the refinement process is complete. Otherwise, the training images with unacceptable predictions are refined by human viewers. The interactive application of FIG. 1 provides the human viewers with strength values and locations to guide them to adapt strength values to what they perceive to be one JND. Watermark embedding is preferably applied in real time to reflect the visual change introduced by updating strength values. The refined JND data is then used to fine tune the model in the training process of block 52. The refinement process then proceeds as described above for a maximum number of iterations or until all predictions are deemed to be within an allowable range of one JND by the panel of human viewers.

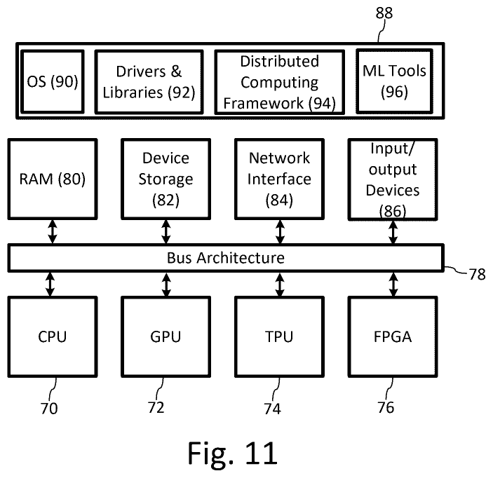

The technology, methods and systems described above may benefit from specialized computing hardware optimized for neural network training and inference operations, particularly given the computational intensity of processing large image datasets and executing complex convolutional neural network architectures. Accordingly, FIG. 11 is a block diagram illustrating an operating environment for components of aspects of the invention. This computing environment includes hardware and software that are useful to optimize training and execution of neural-network models. It is not required for all components of the system, e.g., the interactive user application for capturing JND data. A programmed computer is preferably adapted with components needed to optimize their respective roles, which include AI model training, model execution, user interface application, and/or image processing operations, like image editing and creation, generative image creation, digital watermark embedding and reading, compression, etc. The computer includes a single device with one or more multicore processors, as well as a distributed network of such devices. The form factor of this device may vary, such as a personal computer in various forms, mobile devices (e.g., smartphones), tablet, server, or a network combination of these computing devices.

The computing environment includes processors (e.g., multi-core processors), which include a Central Processing Unit (CPU), Graphics Processing Unit (GPU), and may also include Tensor Processing Unit or like AI accelerators (TPU), and Field Programmable Gate Arrays (FPGAs). The CPU 70 manages general computational tasks and coordinates the overall operation of the system. The CPU executes instructions, manages memory, and handles I/O operations. The GPU 72 is specialized for parallel processing. It accelerates neural-network training and inference by handling multiple calculations simultaneously. This is useful for operations such as the matrix multiplications and convolutions in the neural-networks (e.g., the visibility model and other image processing operations, including watermark reading and embedding). The TPU 74 is hardware optimized for machine learning workloads, particularly for deep learning tasks. TPUs perform tensor operations efficiently, reducing the time and power consumption for training large models. FPGA 76 is configurable hardware that can be tailored for specific neural-network architectures. FPGAs provide a balance between flexibility and performance, allowing for customization of the hardware to meet specific application needs.

The processors 70-76 are connected to and communicate with memory, storage device, a network interface via one or more bus interconnects in the bus architecture 78. The computer preferably has a high-speed bus architecture (e.g., PCIe) to interconnect the CPU 70, GPU 72, TPU 74, FPGA 76, memory (e.g., RAM 80), storage 82, network interface 84, and input/output devices. This architecture is preferably designed to provide efficient data transfer and communication between components.

Memory (RAM) 80 is high-speed Random Access Memory to store active neural-network models, intermediate data, and other variables necessary for computation. Large capacity memory modules ensure that data can be quickly accessed and processed by the CPU and GPU.

Storage Device 82 are preferably solid-State Drives (SSDs) or other high-speed storage solutions to store large datasets, pretrained models, and system software. SSDs provide rapid data retrieval and write speeds, which are useful for handling extensive neural-network data.

Networking Interface 84 provides high-bandwidth network connections (e.g., 10 Gbps Ethernet, InfiniBand) to facilitate data transfer between distributed computing nodes. These interfaces enable scalable machine learning operations across multiple machines.

I/O Devices 86 include visual output devices (e.g., display monitor), audio output devices (e.g., speakers), and user input devices (e.g., keyboards, mice, touchscreens) for interaction with users of the system (e.g., to display training images and capture JND data).

Software Components 88 include the operating system 90, drivers and libraries 92, software for a distributed computing framework 94 and Machine Learning (ML) tools 96. The Operating System (OS) 90 manages hardware resources, provides an environment for application execution, and handles task scheduling. Examples include Linux-based systems and Microsoft Windows.

Drivers and Libraries 92 may include drivers and middleware to optimize communication between hardware components and machine learning frameworks. Examples include CUDA for NVIDIA GPUs and drivers for TPUs and FPGAs.

Distributed Computing Framework 94 is a framework like Apache Spark, Kubernetes, or Horovod to manage and scale machine learning tasks across multiple computing nodes. This software facilitates load balancing, fault tolerance, and efficient resource utilization.

Machine Learning (ML) tools 96 comprise software libraries such as TensorFlow, PyTorch, or MXNet, providing tools and APIs for developing, training, and deploying neural-network models. These tools enable implementation of neural-network architectures and training algorithms, such as the AI visibility model and AI-based image processing, such as digital watermark embedding and reading.

### Example Combinations of Features

Without limiting the scope of the appended claims, the following combinations of features are provided as non-limiting examples that demonstrate specific arrangements and aspects of the present disclosure. Of course, other combinations will be readily apparent from the written description and drawings.

A1. A computer-implemented method for collecting Just Noticeable Difference (JND) training data for neural network visibility models, comprising: executing instructions on one or more multi-core processors to: display a test image on a display device, the test image having an image processing operation applied at varying strength levels across different regions; provide an interactive interface comprising a selection tool enabling a user to identify specific feature locations within the test image where visual artifacts are perceivable; present a strength adjustment control that enables real-time modification of signal strength parameters at selected feature locations while simultaneously updating the displayed test image to reflect the modifications; capture user input indicating a JND threshold strength value for each selected feature location, the JND threshold representing a maximum signal strength at which visual artifacts remain imperceptible to the user; record spatial coordinates of each selected feature location in association with corresponding JND threshold strength values; aggregate the spatial coordinates and JND threshold strength values into a structured training dataset; and output the structured training dataset for use in training a neural network visibility model.

A2. The method of A1 wherein the image processing operation comprises digital watermark embedding with variable embedded strength across spatial regions of the test image.

A3. The method of A1 wherein the strength adjustment control comprises a slider interface that provides continuous adjustment of strength values between predetermined minimum and maximum thresholds.

A4. The method of A1 wherein the real-time modification includes applying the adjusted strength parameters to the image processing operation and refreshing the displayed test image within a response time of less than 100 milliseconds.

A5. The method of A1 wherein capturing user input comprises recording a sequence of strength adjustments made by the user at each feature location, including intermediate values and final JND threshold values.

A6. The method of A1 wherein the feature locations correspond to image patches having dimensions between 10×10 pixels and 20×20 pixels.

A7. The method of A1 further comprising validating user input by requiring the user to confirm JND threshold values through repeated testing at randomly selected feature locations.

A8. The method of A1 wherein the structured training dataset includes metadata comprising image characteristics, user identification, viewing conditions, and display device specifications.

A9. The method of A1 further comprising normalizing the JND threshold strength values based on baseline signal strength parameters applied globally across the test image.

A10. The method of A1 wherein the interactive interface includes visual indicators overlaid on the test image to highlight previously selected feature locations and their corresponding JND threshold values.

A11. The method of A1 further comprising automatically suggesting candidate feature locations for user evaluation based on predetermined image analysis criteria including texture analysis and edge detection.

A12. The method of A1 wherein aggregating the training dataset comprises organizing data by image categories, user demographics, and statistical distributions of JND threshold values.

A13. The method of A1 further comprising quality control validation by comparing JND threshold values across multiple users for identical feature locations and flagging outlier measurements for review.

B1. A neural network system for predicting visibility thresholds in image processing operations, comprising: a feature extraction module comprising a plurality of convolutional layers arranged in a hierarchical structure, the convolutional layers configured to process input image data and generate multi-scale feature representations; a self-attention module integrated within the feature extraction module, the self-attention module configured to weight feature importance based on spatial relationships and feature correlations; an adaptive pooling layer configured to dynamically adjust receptive field sizes based on local image characteristics; a regression module comprising fully connected layers with skip connections, the regression module configured to transform the multi-scale feature representations into continuous strength prediction values; a constraint enforcement module configured to apply domain-specific limitations to the strength prediction values based on perceptual boundaries; and an output interface configured to generate a spatial map of predicted strength values corresponding to input image coordinates.

B2. The system of B1 wherein the hierarchical structure comprises an encoder-decoder architecture with lateral skip connections between corresponding encoder and decoder layers.

B3. The system of B1 wherein the self-attention module implements multi-head attention mechanisms operating across different spatial scales simultaneously.

B4. The system of B1 wherein the adaptive pooling layer adjusts receptive field sizes based on local texture analysis and edge density measurements.

B5. The system of B1 wherein the skip connections in the regression module preserve high-frequency spatial information from the feature extraction module.

B6. The system of B1 wherein the constraint enforcement module applies different limitation ranges based on image content type classification.

B7. The system of B1 wherein the spatial map comprises a multi-channel output representing different types of image processing operations.

B8. The system of B1 further comprising a feedback module that adjusts network parameters based on comparison between predicted strength values and ground truth JND measurements.

B9. The system of B1 wherein the convolutional layers employ depthwise separable convolutions to reduce computational complexity while maintaining feature extraction effectiveness.

B10. The system of B1 further comprising a regularization module that applies dropout and batch normalization selectively based on training phase and convergence metrics.

B11. The system of B1 wherein the feature extraction module incorporates residual connections with learnable gating mechanisms to control information flow.

B12. The system of B1 further comprising a multi-task learning component that simultaneously predicts visibility thresholds for multiple types of image distortions.

C1. A real-time image processing system for generating and applying visibility masks, comprising: a mask generation engine configured to receive input images and produce visibility masks in real-time using a pre-trained neural network visibility model; a parallel processing framework configured to partition input images into processing blocks and distribute mask generation across multiple processing units; a mask refinement module configured to apply spatial smoothing and boundary condition enforcement to generated visibility masks; an image operation controller configured to modulate image processing parameters based on visibility mask values at corresponding spatial locations; a quality monitoring system configured to analyze processed images and detect visibility threshold violations; and a feedback control system configured to adjust mask generation parameters based on quality monitoring results and maintain visibility constraints within predetermined bounds.

C2. The system of C1 wherein the mask generation engine processes input images at multiple resolution levels and combines results to produce multi-scale visibility masks.

C3. The system of C1 wherein the parallel processing framework employs GPU acceleration with memory optimization for processing high-resolution images in real-time.

C4. The system of C1 wherein the mask refinement module applies edge-preserving filters to prevent visibility discontinuities at mask boundaries.

C5. The system of C1 wherein the image operation controller supports multiple simultaneous image processing operations with independent visibility constraints.

C6. The system of C1 wherein the quality monitoring system employs statistical analysis of pixel-level changes to detect potential visibility violations.

C7. The system of C1 wherein the feedback control system implements adaptive learning to improve mask generation accuracy over time.

C8. The system of C1 further comprising a preprocessing module that normalizes input images and applies color space transformations optimized for visibility prediction.

C9. The system of C1 wherein the mask generation engine caches frequently accessed mask patterns to reduce computational overhead for similar image regions.

C10. The system of C1 further comprising a post-processing module that applies temporal consistency constraints for video sequences to prevent visibility flickering between frames.

C11. The system of C1 wherein the quality monitoring system generates confidence scores for mask predictions and flags low-confidence regions for manual review.

C12. The system of C1 further comprising an integration interface that enables incorporation of the visibility mask system into existing image processing pipelines with minimal modification requirements.

D1. A system for controlling visibility of digital watermark embedding comprising: means for receiving JND strength values from a user in response to displaying a watermarked image; means for training a neural-network based visibility model with the JND strength values and corresponding input image features; means for obtaining a visibility mask from the neural-network based visibility model for an input image; and means for applying the visibility mask to control a watermark embedding operation on the input image.

E1. A system for controlling visibility of image operations, the system comprising: a programmed computer system, configured with instructions to display an image with image editing operations applied and obtain JND strength values from a user to control visibility of the image editing operations at feature locations within the image; the programmed computer system, configured with a neural-network, that is trained with the JND strength values for images in training data, the programmed system computer configured with instructions to apply the neural-network to an input image to predict JND strength values, the programmed computer system configured with instructions to transform the JND strength values into a visibility mask; and the programmed computer system, configured with instructions to execute image editing operations using the visibility mask to control changes in image features to be within one JND.

E2. The system of E1 wherein the image editing operations comprise digital watermark embedding operations, and the visibility mask controls strength of a digital watermark to be within one JND.

E3. The system of E2 wherein the digital watermark embedding operations comprise applying a trained neural-network to the input image to produce a watermark signal, and blending the watermark signal with the input image using the visibility mask to control strength of the watermark signal in a watermarked image.

E4. The system of E1 wherein the neural-network comprises feature extractor layers and regressor layers.

E5. The system of E4 wherein the feature extractor layers comprise an input block and residual blocks, the input block and residual blocks each comprising convolutional layers, and wherein the regressor layers comprise a tensor connection layer and output block, the output block comprising fully connected blocks and an output activation function that outputs a predicted JND strength value.

Having described and illustrated the principles of the technology with reference to specific implementations, it will be recognized that the technology can be implemented in many other, different, forms. The particular combinations of elements and features in the above-detailed embodiments are exemplary; the interchanging and substitution of these teachings with other teachings in this and the incorporated-by-reference patents/applications are also contemplated.

1. A method for creating and applying a visibility model of an image comprising:
using one or more multicore processors, performing:
in an interactive user interface, displaying a test image and capturing user input of signal strength for image features within the test image;
presenting a user interface element that enables a user to adjust the signal strength for the image features while viewing the test image on a display device and input a JND signal strength that represents a just noticeable difference of image artifacts at image features;
outputting training data comprising image features and corresponding JND signal strength of the image features within test images;
training a neural-network with the training data to create the visibility model, the visibility model comprising a trained neural-network that predicts JND strength values from input images;
receiving an input image;
transforming the input image with the trained neural-network to produce predicted JND strength values from the input image;
producing a visibility mask from the predicted JND strength values, and
applying the visibility mask in an image editing process on the input image to control visibility of image editing operations on image features corresponding to JND signal strength at locations within the input image.

2. The method of claim 1 wherein the image editing process comprises a digital watermark embedding operations in which the JND signal strength controls the visibility of a digital watermark at image features within the input image.

3. The method of claim 1 wherein the training comprises performing a regression to minimize a difference between predicted strength values and JND strength values obtained by sampling user input through the interactive user interface.

4. The method of claim 3 wherein the training comprises training a convolutional neural-network to predict JND strength at coordinates within a test image by:
transforming pixel values of the test image into features with feature extractor layers of the convolutional neural-network; and
transforming the features into strength values in fully-connected regressor layers of the convolutional neural-network.

5. The method of claim 1 wherein the interactive user interface comprises an input device and the method further comprises receiving user input of selected locations in which a user has adjusted strength with the user interface element to input a signal strength of a digital watermark embedding operation, the signal strength corresponding to what the user perceives to be a just noticeable difference of the digital watermark embedding operation.

6. The method of claim 1, in which, using the one or more multicore processors, further performing:
refining the visibility model:
applying a first mask to a watermark embedding operation to produce a watermarked image;
presenting the watermarked image to a user through an interactive interface to obtain updated JND signal strength for locations within the watermarked image, the interactive interface configured to enable the user to evaluate under or over predictions of strength values relative to a just noticeable difference; and
training the neural-network with the updated JND signal strength;
repeating said applying, presenting, and training for training images until the under or over predictions are within an acceptable range of just noticeable difference.

7. A system for creating and applying a visibility model comprising:
one or more input devices;
a display device;
a computer, comprising one or more multi-core processors, configured with instructions to display a test image and capture user input of signal strength for image features within the test image;
the computer configured with instructions to present a user interface element on the display device that enables a user to adjust the signal strength for the image features using the one or more input devices while viewing the test image on the display device and input a JND signal strength that represents a just noticeable difference of image artifacts at image features;
the computer configured with instructions to output training data comprising image features and corresponding JND signal strength of the image features within test images;
the computer configured to train a neural-network with the training data to create the visibility model, the visibility model comprising a trained neural-network that predicts JND strength values from input images;
the computer configured with instructions to receive an input image, transform the input image with the trained neural-network to produce predicted JND strength values from the input image, and generate a visibility mask from the predicted JND strength values, and
the computer configured with instructions to apply the visibility mask in an image editing process on the input image to control visibility of image editing operations on image features corresponding to JND signal strength at locations within the input image.

8. The system of claim 7 wherein the image editing process comprises a digital watermarking process in which the JND signal strength controls the visibility of a digital watermark at image features within the input image.

9. The system of claim 7 wherein the computer is configured with instructions to perform a regression to minimize a difference between predicted strength values and JND strength values obtained by sampling user input through the one or more input devices.

10. The system of claim 9 wherein the computer is configured with instructions to train a convolutional neural-network to predict JND strength at coordinates within an image by:
executing instructions to transform pixel values of the input image into features with feature extractor layers of the convolutional neural-network; and
transforming the features into strength values in fully-connected regressor layers of the convolutional neural-network.

11. The system of claim 7 wherein the computer is configured with instructions to receive input from the one or more input devices, the input comprising user input of selected locations in which a user has adjusted strength to input a signal strength of a digital watermark embedding operation, the signal strength corresponding to what the user perceives to be a just noticeable difference of the digital watermark embedding operation.

12. The system of claim 7 wherein the computer is configured with instructions to:
apply a first mask to a watermark embedding operation to produce a watermarked image;
present the watermarked image to a user on the display device to obtain updated JND signal strength for locations within the watermarked image, the locations including locations of image features comprising under or over predictions of strength values relative to a just noticeable difference; and
train the neural-network with the updated JND signal strength obtained from the user;
repeat execution of the instructions to apply, present, and train until the under or over predictions are within an acceptable range of just noticeable difference.

13. A computer readable medium on which is stored instructions, which when executed by a computer comprising one or more multicore processors, perform:
in an interactive user interface, displaying a test image and capturing user input of signal strength for image features within the test image;
presenting a user interface element that enables a user to adjust the signal strength for the image features while viewing the test image on a display device and input a JND signal strength that represents a just noticeable difference of image artifacts at image features;
outputting training data comprising image features and corresponding JND signal strength of the image features within test images;
training a neural-network with the training data to create a visibility model, the visibility model comprising a trained neural-network that predicts JND strength values from input images;
receiving an input image;
transforming the input image with the trained neural-network to produce predicted JND strength values from the input image;
producing a visibility mask from the predicted JND strength values, and
applying the visibility mask in an image editing process on the input image to control visibility of image editing operations on image features corresponding to JND signal strength at locations within the input image.

14. The computer readable medium of claim 13 on which is stored instructions, which executed by the computer, perform:
refining the visibility model:
applying a first mask to a watermark embedding operation to produce a watermarked image;
presenting the watermarked image to a user through an interactive interface to obtain updated JND signal strength for locations within the watermarked image, the interactive interface configured to enable the user to evaluate under or over predictions of strength values relative to a just noticeable difference; and
training the neural-network with the updated JND signal strength;
repeating said applying, presenting, and training for training images until the under or over predictions are within an acceptable range of just noticeable difference.

15. The computer readable medium of claim 13, wherein the image editing process comprises a digital watermark embedding operations in which the JND signal strength controls the visibility of a digital watermark at image features within the input image.

16. The computer readable medium of claim 13, wherein the training comprises performing a regression to minimize a difference between predicted strength values and JND strength values obtained by sampling user input through the interactive user interface.

17. The computer readable medium of claim 16, wherein the training comprises training a convolutional neural-network to predict JND strength at coordinates within a test image by:
transforming pixel values of the test image into features with feature extractor layers of the convolutional neural-network; and
transforming the features into strength values in fully-connected regressor layers of the convolutional neural-network.

18. The computer readable medium of claim 13, wherein the interactive user interface comprises an input device and the stored instructions comprise instructs, which executed by the computer, perform: receiving user input of selected locations in which a user has adjusted strength with the user interface element to input a signal strength of a digital watermark embedding operation, the signal strength corresponding to what the user perceives to be a just noticeable difference of the digital watermark embedding operation.
